(19) United States
(12) Patent Application Publication
(10) Pub. No.: US 2013/0035086 A1
(43) Pub. Date: Feb. 7, 2013

(54) REMOTE CONTROL SYSTEM FOR PROVIDING CONTENT SUGGESTIONS

(71) Applicants: Jean-Michel Chardon, Toronto (CA); Sneha Patel, Mississauga (CA); Paul Kirkley, Ontario (CA); Rana Gujral, Ontario (CA); Leslie Persaud, Morges (CH); Kevin Simon, Morges (CH); Eric Raeber, Morges (CH)

(72) Inventors: Jean-Michel Chardon, Toronto (CA); Sneha Patel, Mississauga (CA); Paul Kirkley, Ontario (CA); Rana Gujral, Ontario (CA); Leslie Persaud, Morges (CH); Kevin Simon, Morges (CH); Eric Raeber, Morges (CH)

(73) Assignee: Logitech Europe S.A., Morges (CH)

(21) Appl. No.: 13/332,907

(22) Filed: Dec. 21, 2011

Related U.S. Application Data
(60) Provisional application No. 61/426,508, filed on Dec. 22, 2010.

(51) Int. Cl. H04W 88/02; G05B 19/02

(52) U.S. Cl. 455/420; 340/4.3

(57) ABSTRACT

A portable device configured to control a set of home entertainment appliances includes a processor; and a transceiver coupled to the processor. The transceiver is configured to transmit information to a computer system and receive information from the computer system. The portable device further includes a display coupled to the processor. The processor is configured to: i) collect use information associated with controlling the set of home entertainment appliances, and ii) control the transceiver to transmit the use information to a computer system. The computer system is configured to: i) analyze the use information to determine a set of content related to the use information, ii) generate a set of recommendations that includes information that identifies the set of content, and iii) send the set of recommendations to the transceiver for display of the set of recommendations on the display.

### CROSS-REFERENCES TO RELATED APPLICATIONS

This application is a non-provisional of, and claims priority to, U.S. Provisional Patent Application No. 61/426,508 filed on 22 Dec. 2010, titled “REMOTE CONTROL SYSTEM FOR PROVIDING CONTENT SUGGESTIONS”, by Jean-Michel Chardon et al., the contents of which are incorporated by reference herein in their entirety for all purposes.

### FIELD OF THE INVENTION

The present invention relates to remote control systems for controlling home entertainment appliances in general and in particular to a remote control system configured to suggest or otherwise limit, focus, etc. content to a remote control system user.

### BACKGROUND OF THE INVENTION

Modern remote control systems are typically configured to control a number of entertainment appliances. Modern remote control systems not only perform the basic functions of traditional remote controls, such as turning on and off televisions and changing television channels, but also provide relatively complex features. For example, modern remote control systems are configured to provide interactive programs guides, track the states of a number home entertainment appliances so that the commands issued to a set of home entertainment appliances are executed properly, and are often web-enabled to retrieve current remote control information relatively quickly.

Despite these advances in remote control systems, some tasks have become more complicated for users. For example, simple functions such as finding content to watch on a television, have become increasing complicated. The number of content choices currently available to a user is relatively high, which often leaves users overwhelmed, confused, and unable to find desired content. To name just a few, these content choices can include numerous programs being telecast on TV/satellite, programs that are stored on a user's DVR, video and/or audio programs that are available via subscription services such as Netflix, iTunes®, etc., e-books, pictures, home videos, website informational content, and so on. The content choices may span different mediums, different sources, different platforms, and different timings (e.g., live/instantly available, pre-recorded, to be recorded in the future), and so on.

Thus there is need for apparatus, systems, and methods for reducing to a relevant subset, the number of choices that users have in content selection and consumption. Further, there is need to provide a user with a subset of the content that users have access to, that match the users' viewing habits and/or preferences, regardless of the variation in content type, content sources, and timings. Furthermore, there is a need to provide users with recommendations for content that they may want to watch, across various content sources, content types, etc.

### BRIEF SUMMARY OF THE INVENTION

The present invention relates to remote control systems for controlling home entertainment appliances in general and in particular to a remote control system configured to suggest or otherwise limit, focus, etc. content to a remote control system user. As discussed herein, embodiments of the invention may include remote control devices which transmit commands to entertainment devices; a “blaster”/set-top box type device, which receives commands from a user-manipulated device (e.g., a smartphone or tablet), and transmits commands to entertainment devices based on the information received from the user-manipulated device; as well as other control configurations in which some of the intelligence/functionality of the content processing and/or control is aggregated into one of the entertainment devices (e.g., the TV). The intelligence to analyze, aggregate, and generate a set of recommendations as discussed herein may be on a remote control device, a “blaster”/set-top box type device, a local computer system, a remote server, etc. More generally, aspects of the invention may find applicability in any type of system where the user-interface, the transmission of commands to the entertainment devices, and the intelligence can be distributed in various components of the system.

In accordance with an embodiment of the present invention, a portable device configured to control a set of home entertainment appliances includes a processor, and a transceiver coupled to the processor. The transceiver may be configured to transmit information to a computer system and receive information from the computer system. The portable device may further include a display coupled to the processor. The processor may be configured to: i) collect use information associated with controlling the set of home entertainment appliances, and ii) control the transceiver to transmit the use information to a computer system. The computer system may be configured to: i) analyze the use information to determine a set of content related to the use information, ii) generate a set of recommendations that includes information that identifies the set of content, and/or iii) send the set of recommendations to the transceiver for display of the set of recommendations on the display. According to embodiments, the portable device may be a smart-phone, tablet, or other portable computing device. According embodiments, the portable device may be a remote control device and/or part of a remote control system.

According to one embodiment, the set of recommendations may include a program guide that identifies the set of recommendations. The program guide may be, for example, a television program guide, a web-streaming guide, etc.

According to another embodiment, the portable device may include a user interface (e.g., a set of buttons, rollers, knobs, a touch screen, etc.) coupled to the processor for controlling the set of home entertainment appliances. The set of use information may include user interface information for interaction with the user interface (e.g., button press information for one or more buttons, “soft button” configuration information, etc.). The use information may also include geographic information for a location at which the portable device is used. In one embodiment, the computer system or other component of a control system may be configured to generate an initial set of recommendations based on the geographic information; and/or filter the initial set of recommendations based on the user interface information (e.g., button press information) to generate the set of recommendations.

In one embodiment, the use information may include favorites information for a user of the portable device. The computer system or other component of a control system may be configured to generate an initial set of recommendations based on the geographic information and/or filter the initial set of recommendations based on the favorites information to generate the set of recommendations.

According to another embodiment, the use information may include time information for a time at which the portable device is used by a user to control the set of home entertainment appliances. The computer system or other component of a control system may be configured to filter an initial set of recommendations to remove information from the initial set of recommendations for programs that are not at one or more times included in the time information to thereby generate the set of recommendations.

According to another embodiment, the use information may include channel information, such as for television, gaming, radio and/or streaming channels, that are streamed, watched and/or listened to. The time information may identify the times at which the channels are streamed, watched and/or listened to. The computer system or other component of a control system may be may be configured to filter an initial set of recommendations to remove channels not included in the channel information to generate the set of recommendations.

According to another embodiment the computer system or other component of a control system may be configured to access a content database that includes user-favorites information, e.g. for content identified to the computer system by a plurality of portable-device users via the portable-device users' portable devices or other networked devices. According to one embodiment, systems may be configured to generate an initial set of recommendations based on the user-favorites information and filter the initial set of recommendations based on the use information to generate the set of recommendations. The use information may include at least one of user interface information (e.g., button press information), channel information, time information, geographic information, broadcast information, and/or favorites information.

According to another embodiment, the set of recommendations may include cross-platform recommendations. A cross-platform recommendation may include a recommendation for a type of media that is different from a type of media associated with the use information.

According to an embodiment of the present invention, a method for suggesting content to a user may also be provided. Exemplary methods may be implemented at a server system comprising one or more server computers or running in a cloud computing environment. The server system may receive use information from a portable device. The portable device may be configured to control a set of home entertainment appliances, control a set of network services; and control a set of content sources. The use information may include information about how the device has been used to control the home entertainment appliances. The server system may then access a content database configured to store content information for content and compare the use information received from the portable device with content information to determine if a portion of the content information is related to a portion of the use information. The server system may further determine a set of recommendations for a portion of the content information, which is related to the portion of the use information; and send the set of recommendations to the portable device, where the information may be displayed to a user of the device. In embodiments, the information may be received from another device such as a blaster/set-top box type device (e.g., Logitech Revue), rather than from a portable device.

According to another embodiment of the present invention, a method for suggesting content to a user is provided. The method may be implemented at a portable device configured to control a set of home entertainment appliances, control a set of network services; and control a set of content sources. The device may collect information about how it is used to control those devices and send that information to a server system including information about the device, the commands issued on the device and programming consumed by the user. The device may then receive information about content recommendations from the server system including recommendations for particular programs or particular channels. The device may then present these recommendations to the user on a display including options for the user to activate the recommendations.

According to another embodiment of the present invention, a portable device that is configured to control a set of home entertainment appliances may include a processor configured to execute a program, and a memory configured to store code for the program and supply the code to the processor. The portable device further includes a transceiver coupled to the processor and configured to transmit information to a computer system and receive information from the computer system. The portable device further includes a user interface (e.g., set of buttons, touch screen, touch pad, etc.) coupled to the processor and configured to receive user input for controlling the set of home entertainment appliances. The portable device may further include a display coupled to the processor. The processor may be configured to: i) store user interface information for the user interaction with the user interface (e.g., button press information for button presses of buttons, touch pad swipes or presses, etc.), and ii) control the transceiver to transmit the user interface information (e.g., button press information) to the computer system. The computer system may be configured to: i) analyze user interface information (e.g., the button press information) to determine a set of content related to the user interface information, ii) generate a set of recommendations that includes information that identifies the set of content, and/or iii) send the set of recommendations to the transceiver for display of the set of recommendations on the display. According to embodiments of the invention, the portable device may be a remote control device, a game controller, a smart-phone device, a tablet computer, or other portable computing device.

According to embodiments, the processor may be further configured to: i) analyze the user interface information (e.g., the button press information) to determine a set of program information associated with the user interface information, and ii) control the transceiver to transmit the set of program information to the computer system. The computer system may be further configured to: i) analyze the set of program information to determine additional content for the set of content where the additional content is related to the set of program information, ii) generate additional recommendations for the set of recommendations, and/or iii) transmit the set of recommendations to the transceiver for display of the set of recommendations on the display. According to another embodiment, the computer system may be a server system. In embodiments, the server system may be located remotely from the portable device and the media devices may be controlled by the portable device.

According to another embodiment of the present invention, a method of operation of a remote control system for suggesting content to a user may include collecting use information for use of a portable device, which is configured to control a set of home entertainment appliances. The use information may be transferred from the portable device to a server system. The server system may access a content database configured to store content information. Examples of the content in the database may include, for example, a back-end Electronic Programming Guide (EPG). The server system may compare the use information with content information to determine, for example, if a portion of the content information is related to a portion of the use information. The server system may then generate a set of recommendations for a portion of the content information, which is related to the portion of the use information. The set of recommendations may be transferred from the server system to the portable device, or other computing device, and may be displayed on the portable device, or other display available to the user. The portable device may be, for example, a remote control device, a smartphone device, or other portable computing device, among other things. In one embodiment, the database may be continually updated with information provided by various portable devices. Some embodiments of such a database are included in U.S. Pat. No. 7,436,319, titled “Method an Apparatus for Uploading and Downloading Remote Control Codes,” of Glen McLean Harris et al., the contents of which are incorporated herein by reference.

The portion of content information may be considered to be related to the portion of the use information if, for example, a genre of the portion of content information is the same as a genre for the portion of the use information. Alternatively, the portion of the content information may be for the same media type as a media type of the portion of the use information. According to embodiments, the portion of the content information may be for a different media type than a media type of the portion of the use information.

Some embodiments of the present invention provide an apparatus, a system and/or a method for reducing to a relevant subset, the number of choices that users have in content selection and consumption. A user may be provided with a manageable subset of relevant choices out of a relatively large number of available content options, of different media, and/or from different sources. Further, a user may be provided with a subset of the content that user has access to, which match his viewing habits and/or preferences.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a simplified schematic of a remote control system according to one embodiment of the present invention;

FIG. 2 is a simplified circuit diagram of a circuit that may be included in the remote control device in accordance with one embodiment of the present invention;

FIG. 3 is a high-level flow diagram of a method of operating the remote control system to provide a set of recommended content to a user via the remote control device in accordance with one embodiment of the present invention; and

FIG. 4 is a high-level flow diagram of a method for collecting data for various content, services, games, etc., and for generating and providing suggested content to user based on the collected data in accordance with one embodiment of the present.

### DETAILED DESCRIPTION OF THE INVENTION

The present invention provides a remote control system for controlling home entertainment appliances in general and in particular provides a remote control system configured to suggest, or otherwise limit, content presented to a remote control system user.

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. For example, although certain embodiments including control devices and functionality included in universal remote controls, smartphones, and the like may be described for convenience, the invention may include other control devices and systems without limitation to universal remote controls, smartphones, or other specifically described devices. It also is to be noted that as used herein and in the appended claims, the singular forms “a,” “an,” and “the” include the plural reference unless the context clearly dictates otherwise. Thus, for example, a reference to “a button” is a reference to one or more buttons and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

As mentioned above, exemplary embodiments of control devices may be described herein as having a touch interface and a software application operating on, for example, a remote control device or smartphone to control remotely located appliances and/or applications/services operating on those appliances. However, the various embodiments described herein are not limiting on the claims or the scope and purview of the present invention. For example, a control device as described herein may be a universal remote control, a keyboard, a tablet, or the like and may include the touch interface and the software applications described for executing the method of the present invention.

### Remote Control System

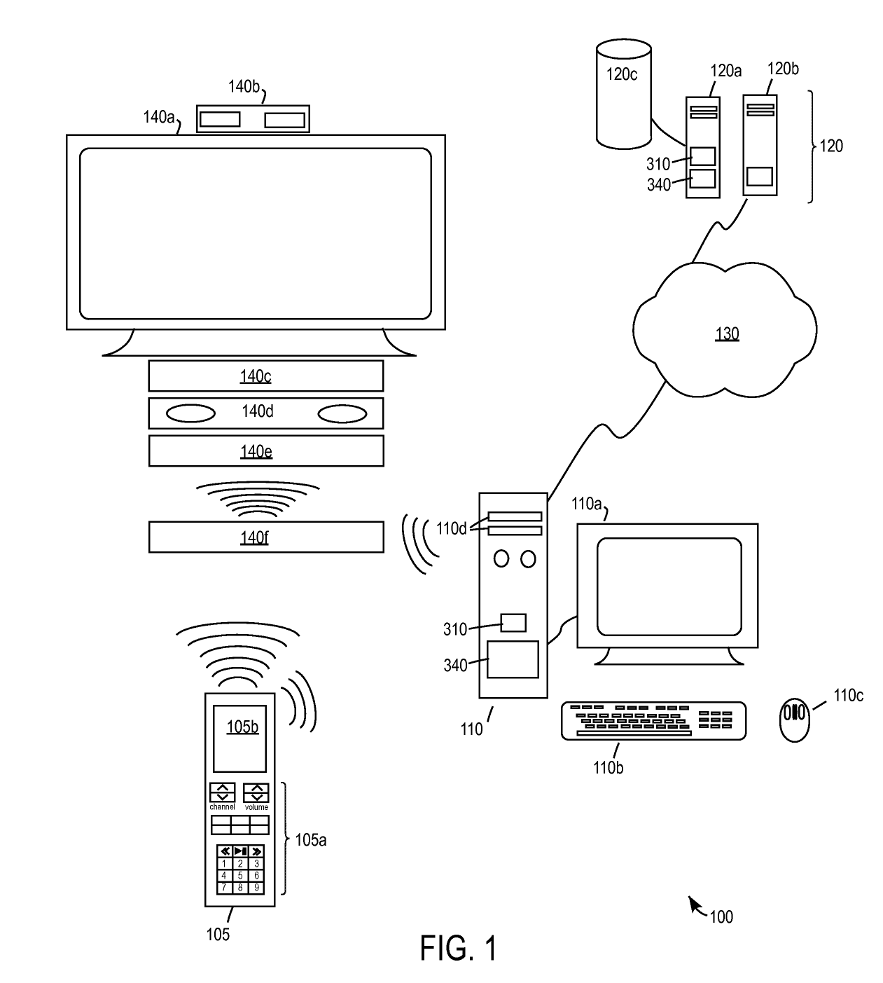

FIG. 1 is a simplified schematic of a remote control system 100 according to one embodiment of the present invention. Remote control system 100 includes a remote control device 105, a computer system 110, and a server system 120. Either or both the remote control 100 and the computer system 110 may be configured to communicate via a network 130 (e.g., the Internet, an intranet, etc.) with server system 120. Remote control device 105 may also be configured to communicate with computer system 100 to thereby communicate with server system 120 via network 130.

According to one embodiment, remote control device 105 is configured to control a set of home entertainment appliances 140. A set as referred to herein includes one or more elements. The set of home entertainment appliances may include a television 140a, a set-top-box 140b (e.g., a cable receiver, a satellite receiver, etc.), a DVD player 140c, a surround sound system 140d, a CD player 140e, a bridge 140f, etc. It should be noted that some to all of the intelligence relating to various embodiments of the present invention may be on the bridge, and/or various steps described herein may be performed on/by the bridge. The remote control device might be a universal remote control, a smart phone configured to perform remote control operations, a personal digital assistant configured to perform remote control operations, or any other similar control or computing device. In an embodiment of the invention, a smart phone is configured to perform remote control operations by means of an application downloaded to the smartphone from an app store. In another embodiment of the invention a web site or web app is used.

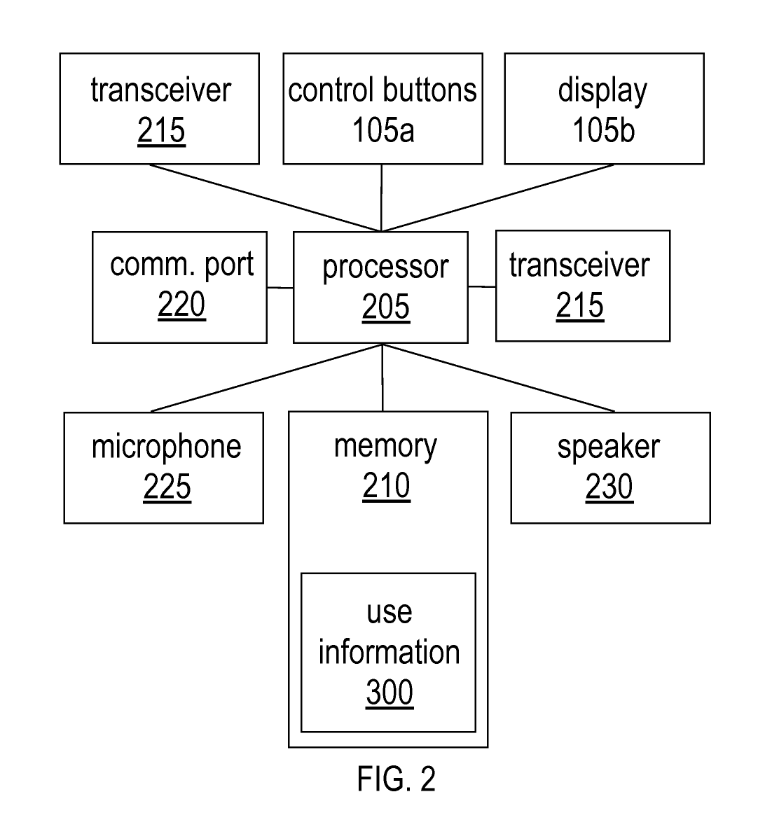

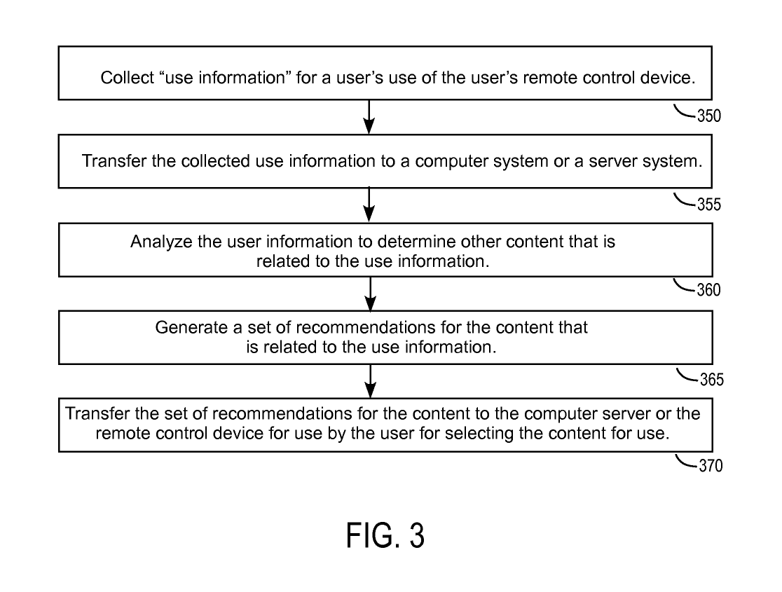

Remote control device 105 may include a user interface 105a (e.g., a set of control buttons) and a display 105b. For convenience, the remainder of the specification discuss interaction with a set of control buttons and the collection of button press information. It will be understood that any description of the set of buttons and the button press information is applicable to the broader user interface and user interface information (i.e., information collected from a user's interaction with the user interface). The portable remote control device may also include other user interface elements to which a user can provide input. For instance, a touch screen may be included, which could have soft buttons, as well as the ability to recognize certain gestures (e.g., swiping etc.). As another example, remote control device 105 may be configured to recognize gestures that may include movement of the entire device, shaking, changes in orientation, changes in ambient light, movement of a user's face, hands, etc. The remote control device 105 may include location sensors such as a GPS, an accelerometer, a microphone, speech recognition system, a camera, an image recognition system, a gyroscope, etc. All of these are examples, and the embodiments of the present invention are not limited to these specific examples. Any type of input provided by the user may be recognized by the remote device 105, and used for various embodiments of the present invention. FIG. 2 is a simplified circuit diagram of a circuit 200 that may be included in a device 105 in accordance with an embodiment of the present invention. FIG. 3 is a high-level flow diagram of a method of operating the remote control system described above in accordance with an embodiment of the present invention. The high-level flow diagram of FIG. 3, circuit 200 shown in FIG. 2, and the remote control system will be described herein jointly. Circuit 200 may include a processor 205, a memory 210, a transceiver 215, a communication port 220 (e.g., electronic or optical), the set of control buttons 105a, and the display 105b. According to a further embodiment, circuit 200 may include a camera (not shown), a microphone 225 and/or a speaker 230. The user-interface elements (e.g., the buttons, display, etc.) may be in a separate device (e.g., smartphone or tablet), and some of the other components may be in a different device (e.g., bridge, set-top box, integrated into one of the entertainment devices such as the TV, etc.).

The processor may be configured to control each of the other elements of the circuit for performing the remote control operations on the remote control device, and for performing communication operations with computer system 110 and/or server system 120. For example, the processor may be configured to control the transceiver for communication with the set of home entertainment appliances, with the computer system, with the network, and/or with the server system. It will be understood by those of skill in the art that some of the home entertainment appliances may be configured to receive communications (e.g., command codes) from the remote control device's transceiver but may not be configured to send communication to the remote control device, whereas other of the home entertainment appliances may be configured for two-way communication with the remote control device. Further, while the transceiver is shown herein as a single communication module, the transceiver may include a number of communication modules, such as one or more infrared transmitters and infrared receivers, one or more radio frequency transmitters and radio frequency receivers, etc. For example, some manufacturers' devices use a non-standard high-frequency IR transmission system. In an embodiment of the invention, different transmitters are used for different devices. In an embodiment of the invention, some of the devices are connected to a computer network such as Bluetooth, WiFi or Ethernet. Where the control device is a smartphone or a PDA or similarly connected device, it may be possible for the device to communicate directly with these devices, whereas it may be necessary to use an external transmitter to communicate with devices that only accept IR or RF signaling. In an embodiment the control device switches between these signaling methods transparently to the user. In another embodiment, the control device may first try to establish communications with the device over a computer network and fail over to IR or RF only if it is not able to establish a connection over the computer network.

While the set of control buttons is shown in FIG. 1 as being separate from the display, according to some embodiments, some or all of the control buttons may be screen buttons on the display. According to alternative embodiment, remote control device 105 may include a motion detector for detecting gestures of a user where the detected gestures are inputs for controlling the remote control device. The remote control device may also include a speech recognition unit for recognizing voice commands, or may use a network speech to text service by transmitting a recording of the voice command to a remote server and receiving information about commands included in the voice recording from the server. The display may be a touch display and the control button on the display may be activated by touching the display. It will be appreciated by those of skill in the art that, as processing power continues to expand for portable devices, as well as the expanded use of local networking capabilities, the specific functions performed by the remote control, or other local computing device may expand as well.

Memory 210 may be configured to store program code for a plurality of computer programs that may be executed by the processors. For example, for an embodiment of the remote control device that includes a microphone, the remote control device may be configured to store and execute program code for a voice recognition program where a user may be able to speak a command into the microphone, and the voice recognition program will recognize the command and direct the processor to execute the command. For example, the voice recognition program executed on the processor may be configured to recognize the command, “turn on the DVD player and play the DVD.” The voice recognition program may provide commands to the processor to send command codes to the DVD, and any other home entertainment appliances (e.g., TV, surround sound system, etc.) necessary, to play the DVD.

According to one embodiment, computer system 110 is a personal computer, such as a desktop computer, a laptop computer, a tablet computer, a netbook computer, or the like. Computer system 110 may include a monitor 110a, and a set of human interface devices (HIDs), which may include a keyboard 110b and a mouse 110c (or the like, e.g., a trackball, a joystick, a puck, etc.). Computer system 110 may also include a computer readable memory 110d, which may be a magnetic memory, an optical memory, a solid state memory, or the like. Server system 120 may include one or more server computers 120a, 120b, etc. where each server computer is configured to operate a server operating system. Server system 120 may include substantially similar components as those components of computer system 110 discussed above, such as a monitor, HIDs, memory, etc. The server system may include, or may be coupled to, a content database 120c where the content database is configured to store command codes and the like that are used by the remote control device for controlling the set of home entertainment appliances. The content database may also be configured to store content information (e.g., program guide information) for content. The content database may also include a back-end Electronic Programming Guide (EPG).

According to one embodiment, the remote control device is configured to collect and store in memory 210 use information 300 (step 350, FIG. 3) of a user's use of the remote control device. For example, the remote control device may be configured to collect and store button press information for button presses on the set of control buttons 105a. Further, the remote control device may by configured to collect and store time information for the time at which the button presses occurred. The button press information and the time information collected by the remote control device may be stored in use information 300. It will be understood that while button press information is described specifically, the descriptions applies to embodiments of the remote control device where gesture information is collected, swipe information for swipes on a touchpad, etc.

The remote control device may be configured to collect more detailed information regarding the button presses. For example, the remote control device may be configured to determine and store channel information for television channels associated with the button presses. The channel information by be associated with a number of a control button pressed by a user or may be determined from an examination of a program guide that might be stored on the remote control device. The channel information may also be determined by audio recognition of the programming content recorded using a microphone embedded in the control device. The channel may then be determined by transmitting the recording or data derived from the recording to a server including a database with information about programming. If the programming on the channel is known to the server it may be able to identify the program and look up the TV channel showing the program. If the programming is not know or is being transmitted for the first time the server, if it has access to the relevant channel, may be able to identify it in real-time or near real-time by comparing the recorded information to the stream from various channels. If real-time information is not needed, the analysis can be postponed until a time when the programming is complete and a recording is available for comparison. By using audio signatures to determine the program being watched it may also be possible to identify programs that have been paused or recorded using a digital video recorder (DVR). In this manner the control device may also be able to determine whether the user is viewing advertising between programming or whether it is being skipped using the DVR. The channel information may include channel change information, which includes a channel number that was being viewed, and a channel number that is changed from the channel that was being viewed. The time information discussed above may also include an amount of time any given channel is watched. The time information may also include a day of the week on which a given television channel is watched. The channel information collected by the remote control device may be stored in use information 300.

As is discussed in further detail below, use information 300 may be sent to the database on the server, where there is information for the relationship between channel numbers and specific channel, as well as a back-end EPG, which included information for programs that were playing on a given channel at a given time. This is one way in which the remote control system “knows” the programs that the user tunes in to and likes. The programs may then server as the bases for program recommendations.

The remote control device may be configured to collect and store program information, for example, for programs viewed on a given television channel at a given time. For example, if the remote control device is configured to store a program guide for programs available for viewing in a user's geographic area, the remote control may be configured to determine from the button presses on the set of buttons the television channels viewed, the time the channel is viewed, and compare this information with the program guide to determine a program viewed. The comparison may also be made at the server where the server has access to the backend EPG. The program information for the program viewed may include a variety of information, such as the title of the program, various actors in the program, the genre of the program (e.g., drama, comedy, reality TV, sports, football, etc.), or the like. The program information collected by the remote control device may be included in use information 300.

The remote control device may also be configured to collect and store geographic information for where a user is located and using the remote control device. The geographic information may include a ZIP code, a street address, a town name, a specific geographic identifier for a broadcast region of a specific broadcaster (e.g., cable broadcast San Francisco Bay Area, satellite broadcast western North America, etc.), or the like. The remote control device may also collect and store broadcaster information for a broadcast from which a channel is watched on the television. The broadcaster information may include a name for a cable broadcaster (e.g., Comcast™), a satellite broadcaster (e.g., DirectTV™), a traditional RF broadcaster (e.g., NBC™), an Internet broadcaster (e.g., YouTube™, Yahoo™, etc.). The broadcaster information may include broadcast “package” information that identifies a broadcast package that a user subscribes to. For example, the broadcast package information may include information that the user subscribes to a “basic” cable package, but not to a movie channel or a sports channel. According to an alternative example, the broadcast package information may include information that the user subscribes to a basic cable package and a “premium” movie channel. The geographic information and the broadcaster information collected by the remote control device may be stored in use information 300. In an embodiment of the invention, the control device is connected to an internet connection provided by the same company providing the television service; in such cases, the control device may be able to determine both the provider and location using information about the assigned IP address of the device or router.

The remote control device may also be configured to collect website information for the websites a user browses. The website information may include Web addresses (e.g., uniform resource locators, uniform resource identifier, etc.) for the websites, may include topics of websites (e.g., movie, automobile, mobile telephone, etc.), etc. According to one embodiment, the set-top box, bridge, gaming console etc. is web enabled and the remote control device is configured to collect the website information for the websites that the set-top box, bridge, gaming console, etc. accesses. The remote control device may be configured to control the set-top box, bridge, gaming console etc. for Web browsing and collect the website information from this remote control device. The website information may be stored in the use information 300.

Alternatively, computer system 110 is configured to collect a website information for websites the users browses using the computer system. The website information may include the information described above. The website information collected by the computer system may store the website information in use information stored on the user computer.

According to another embodiment, one or both of the remote control device and the computer system are configured to prompt a user to enter favorites information. The favorites information may identify favorite content of a user. For example, the favorites information may include titles for media, genres for media, actors names, musicians names, band names, type information for media, type information for music, etc. Titles for media may include the titles of movies, titles of television programs, titles of CD, titles of books, etc. Type information for media may identify the genres that the media belongs to, such as horror, comedy, drama, reality, sports, etc. Type information for music may identify genres that the music belongs to, such as rock, classical, baroque, hip-hop, etc. Favorites information may also include time information and/or information for the days for which the user will use the set of home entertainment appliances. The favorites information may be stored in use information 300.

According to another embodiment, the remote control device may be configured to collect CD information for a CD that may be played on the CD player. The CD information may include band information, singer information, CD titles, CD track information (e.g., titles of individual songs on a CD), etc. The remote control device may be configured to be in two-way communication with the CD player to collect the CD information. The CD information may include time information, such as that described above, for specific times that a given CD is played, specific times that a given track on a CD is played, specific times that particular artist is played, etc. The control device may also determine the CD being played by recording the played sound using a microphone and using audio signature analysis to determine the song or album being played. The remote control device may be configured to collect similar DVD information for DVDs played on the DVD player. For example, the remote control device may be configured to collect DVD titles, actor's names in movie recorded on a DVD, the times and days particular DVDs are played on the DVD player, etc. The DVD player, similar to the CD player, may be configured to be in two-way communication with the remote control device to provide the DVD information to the remote control device. Like CD information, DVD information may also be determined by recording the sound output from the DVD and identifying it using audio signature analysis. The CD information and the DVD information may be stored in use information 300.

According to one embodiment, the remote control device is configured to collect the foregoing described use information 300 for a set of users of the remote control device. The use information collected for each user may be specifically associated with the user. The remote control device may identify each user by a variety of methods. For example, the remote control may be configured to receive a voice command (e.g., a spoken name) to recognize a user, a series of button presses (e.g., a spelled name, a password, etc.), or the like to recognize a user using the remote control device. The remote control may be configured to identify a user based on the use information that the remote control device has collected for a set of users. The remote control device may be configured to compare the use information previously collected with use information currently collected. For example, if use information previously collected indicates that user 1 (and no other users) uses the set of home entertainment appliances from 7:30 am to 8:30 am weekday mornings, and the remote control device is currently being used on a Monday morning at 7:30 am, then the remote control device may determine that user 1 is using the set of home entertainment appliances. According to an alternative example, if the use information previously collected indicates that user 1 (and no other users) watches reality TV shows on Thursday nights at 8pm, then the remote control device may determine that user 1 is using the remote control device. Those of skill in the art will recognize other methods for using the use information previously collected and use information currently collected to identify a user from a set of users, and these other methods are considered by part of the instant described embodiment.

The remote control device may be configured to transfer the collected use information 300 (e.g., button press information, channel information, time information, broadcaster information, browsing history, etc.) to one or both of computer system 110 and server system 120 (step 355, FIG. 3). According to one embodiment, if computer system 110 receives the use information from the remote control device, the computer system may be configured to transfer the use information to server system 120. The computer system may also be configured to send use information 300 (e.g., browsing history) collected by the computer system to the server system.

The computer system and/or the server system may be configured to analyze (step 360, FIG. 3) the use information and generate a set of recommendations 310 (step 365, FIG. 3) for content (e.g., TV programs, music, movies, products, etc.) that the user may enjoy. According to one embodiment, one or both of the computer system and the server system may be configured to store and execute program code for a recommendation engine 340. The recommendation engine may be configured to analyze the use information to generate the set of recommendations 310. The set of recommendations may include a variety of information, such as a TV program guide, titles for TV programs, title for movies, titles for CDs, titles for books, links to websites, etc. The set of recommendations may organize the information in text, tables, database structures, compiled computer code executable on the remote control device, metadata, and the like.

The recommendation engine may be configured to analyze the use information to determine use patterns, to determine correlations between various pieces of information in the use information, to determine user interests, and the like. The recommendation engine may be configured to generate the set of recommendations based on the determined patterns, the determined correlations, and the determined user interests. Subsequent to the recommendation engine generating the set of recommendations, the recommendation engine may be configured to filter the set of recommendations based on a set of criteria. The set of criteria may include portions of the use information supplied to the recommendation engine. For example, the recommendation engine may be configured to filter the set of recommendations based on the time that a user typically uses her home entertainment appliances. The set of recommendations prior to filtering are sometimes referred to herein as the initial set of recommendations.

In an embodiment of the invention the user activity data is stored in a database by the server. The information may be stored in raw form such that each action is stored in the database; for example each button pressed or gesture performed may be stored with a reference to the user and or control device as well as other relevant information such as physical location, time of day, etc. These entries may then be aggregated in real-time as they are received or by a background process such as Apache Hadoop platform for distributed computing. This process may then be used to generate user profiles or user patterns that the system can access in real time to provide suggestions to the user or to predict what the user is doing. For example a profile can be established for each control device or for each user. Similarly, more generic profiles may be established for users meeting certain criteria, i.e. male Comcast subscribers between 25 and 30 years old in zip code 97456.

The set of recommendations is transferred from the computer server and/or server system to the remote control device (step 370, FIG. 3). If the set of recommendations is generated on the computer system, the set of recommendations may be made available to a user on the computer system or may be sent to the remote control device. Alternatively, the set of recommendations may be transferred from the server system to the computer system where the user might access the set of recommendations. A user of the remote control system may access the set of recommendations on the computer system or on the remote control device. The set of recommendations may be organized on the remote control device as a program guide with channel information and time information for a broadcast. The set of buttons may be used to directly select a piece of content in the program guide for viewing, listening to, or the like. That is, selection of a piece of content may cause a set of command codes to be sent to the set of home entertainment appliances so that the piece of content will play on the set of home entertainment appliances without additional button presses required by the user. For example, the set of command codes may cause the TV to be turned on and tuned to the appropriate channel, the set-top box may also be tuned to the appropriate channel, the surround sound system may turned on/off, etc.

Generation of the set of recommendations is described in further detail immediately below. According to one embodiment, the recommendation engine is configured generate a set of recommendations for content (e.g., TV programs, movies, music, etc.) based on the geographic information, e.g., zip code, broadcaster, location information determined from a GPS (global positioning system), etc. For example, the computer system and/or the server system may be configured to access content database 120c, which includes content information for a plurality of geographic regions, and a plurality of broadcasters. The computer system and/or the server system may be configured to retrieve the content information for the specific geographic information for a user provided in the use information. The set of recommendations that is generated based on the geographic information is referred to as the initial set of recommendations in the following paragraphs. Based on the user's geographic information a set of recommendations may be generated for the programs that other people are watching in the same geographic area (e.g., same city, same state, etc.) are watching. For example, the server may be configured to determine that given program is relatively well like and broadly watched in the San Francisco Bar Area, and the user in the in the San Francisco Bay Area, therefore, the set of recommendations for the user will include the given program.

According to one embodiment of the present invention, the use information received by the recommendation engine may include the channel information and the time information for the times and/or days on which the channels were watched. The recommendation engine may be configured to filter the initial set of recommendations based on the channel information and/or the time information. For example, the recommendation engine may be configured to remove items (e.g., filter) from the initial set of recommendations that are not associated with the time information. That is, the recommendation engine may be configured to remove items (e.g., programs recommendations) from the initial set of recommendations that are not in the time window or on the days that a user has specified that she watches television or the like. The recommendation engine may similarly be configured to remove items from the initial set of recommendations that have channels that are different from the channels specified in the channel information.

According to one embodiment, the recommendation engine is configured to generate an initial set of recommendations for items (e.g., program recommendations) that are popular in the geographic location, which is specified in the use information. The popularity of items in a geographic location may be based on traditional rating systems or may be based on recommendations and/or (aggregate) use patterns and/or viewing patterns from other users of similar remote control devices and the like. The initial set of recommendations may include recommendation from a social network. For example, the set of recommendation may include recommendations from a user's friends on Facebook™, or from people a user is following on Twitter™. The initial set of recommendations may be filtered as described above before the set of recommendations generated from the initial set of recommendations is sent to the computer system and/or the remote control device. When the device is linked to a user's account with a social network, the control device may also show the user a list of their friends who are currently watching television and what they are watching. The list may be sorted based on the closeness of the friendship, which program the user is most likely to want to watch, or any other information. The interface may also allow the user to chat with the users.

According to another embodiment of the present invention, the favorites information, which is included in use information 300, may be used by the recommendation engine to generate an initial set of recommendations for a user or filter a set of initial set of recommendations. According to one embodiment, the recommendation engine may be configured to compare favorite items identified in the favorites information with content in the content database to determine whether content in the content database matches (i.e., correlates with) the favorite items. If the content matches (i.e., correlates with) the favorite items, the recommendation engine may be configured to place a content identifier for the content in the initial set of recommendations. Alternatively, the recommendation engine may be configured to identify one or more pieces of attribute data associated with a favorite item in the favorites information. For example, the recommendation engine may be configured to identify a genre of a movie identified as a favorite movie. The recommendation engine may be configured to identify a genre of a TV program or TV series identified as a favorite TV program or TV series. According to a further example, the recommendation engine is further configured to identify one or more actors in a favorite movie, a favorite TV program or the like. The recommendation engine may also be configured to identify music played in a favorite movie, a favorite TV program, etc. The recommendation engine may be configured to identify movies, television shows, music, books, websites and the like in an identified genera. The recommendation engine may be configured to identify movies, television shows, music, books, websites and the like that include a favorite actor. The recommendation engine may be configured to generate the initial set of recommendations that include identifiers (e.g., titles, etc.) for the identified movies, TV programs, TV program guide for the TV programs, DVDs, CDs, music, books, websites, etc. The initial set of recommendations may be filtered (e.g., based on the geographic information or broadcaster information) prior to sending the set of recommendations to the computer system and/or the remote control device, or may be sent un-filtered to the computer system and/or the remote control device. The set of recommendations may be presented on the computer system or the remote control device as a program guide (discussed above). Alternatively, items in the set of recommendations may not be available for broadcasting in the user's geographic regions, but none-the-less may be recommended on the computer system or the remote control device for alternative access, such as via electronic download from a website, or via purchase on DVD, CD, etc. from a traditional retailer or a web based retailer.

According to one embodiment, the recommendation engine may be configured to identify music in the same genre as the music from a movie where the movie is included in the use information, in the favorites information, or otherwise identified by the recommendation engine. The recommendation engine may be configured to generate an initial set of recommendations that includes music titles for the music. The set of recommendations may include information for locations (e.g., street addresses for traditional “brick and mortar” store, websites for Web based stores, etc.) at which the music in the set of recommendations may be purchased. According to one embodiment, the information for a location may be a link to a website for on web based retailer. The initial set of recommendations may be filtered prior to sending the set of recommendations to the computer system or the remote control device, or may be sent un-filtered to the computer system and/or the remote control device. The foregoing is an example as a cross-media recommendation. That is, one type of media is provided to, or determined by, the recommendation engine, and the recommendation engine generates a recommendation for another type of media. A cross-platform recommendation (as compared to a cross-media recommendation) may include the same type of media being recommended. For example, a TV program may be recommended in a set of recommendations based on some recently watched programs on DVDs.

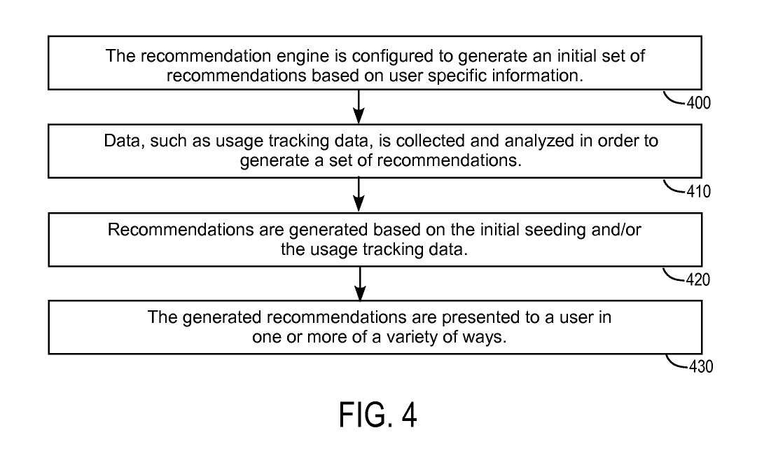

FIG. 4 is a high-level flow diagram of a method in accordance with an embodiment of the present invention for collecting data for various content, services, games, etc., and for generating and providing suggested content to user based on the collected data. The high-level flow diagram is exemplary and those of skill in the art will recognize that various steps may be combined, added, or omitted without deviating from the spirit and purview of the present invention. The high-level flow diagram is not limiting on the claims.

### Initial Setup and Seeding

According to one embodiment of the present invention, the recommendation engine is configured to generate an initial set of recommendations based on user specific information, step 400. The generation of the set of recommendation is sometimes referred to herein as seeding the set of recommendations. This step includes the tasks of obtaining information about a user that will be helpful to the recommendation engine in generating a set of recommendation regarding suitable content for the user. The following are examples of the kinds of information which may be used for the “initial” seeding:
(i) Content Sources To Which The User Subscribes: The content sources may include the source of the TV /cable broadcast (e.g., Dish, Satellite), various services (e.g., Netflix™, other media sources such as Hulu Plus™, etc.), RSS feeds, Twitter™ accounts, social networks (e.g., Facebook™, etc.), the particular channels/package the user subscribes to for any of these cable or other services, and so on.
(ii) Content Sources Available: The content sources available may include content sources available that the user has not yet subscribed to. In some embodiments, the initial seed of content sources available could lead to subscription suggestions along with content recommendations. For instance, the user could be provided with an option of watching “XYZ movie”, along with the suggestions re: possible sources, some or all of which the user may not have subscribed to. For example, the user may see a message like this: “XYZ movie is available for instant viewing on Netflix. Would you like to subscribe to Netflix?” Further, if the user makes the appropriate choice, the user may be taken to the appropriate service, and/or the system may seamlessly subscribe to the service on the user's behalf. In such a situation, the seeding information may include some payment and/or subscription information (e.g., credit card information, desired user-id and password, etc.)
(iii) Source Preferences: The source preferences may include an ordering of the user's preferences by source (e.g., live, recorded, DVD, set-top box, service, etc.). For instance, the users top preference may be a show taped in HD on his DVR, the next preference may be a show taped on this DVR in non-HD, and so on, while the last preference may be a pay-per-view subscription service. Such a source preference seeding will allow a system in accordance with an embodiment of the invention to take into account these source preferences when providing content recommendations.
(iv) User Content Preferences: The content user preferences may include the user's preferences for content, such as preferred actors, directors, preferred types of content such as documentaries, movies, sports, comedy, preferred content at different times (e.g., comedy shows on weekday evenings, movies on weekend evenings, kids shows during afternoons, etc.)
(v) Differentiating Between Various Users: Different users are identified, in one embodiment. This may be done by using names, categories (e.g., kids, adults, etc.), fingerprints, and so on. Further, instead of or in addition to seeding, during the data collection and analysis stage, different users may be identified based on usage patterns tracked.
   Other types of seeding information may also be included. In various embodiments, the initial setup or seeding may be active or passive. In some embodiments, the user may have a choice of whether to actively seed. In one embodiment, if a system in accordance with an embodiment of the present invention is not actively seeded, the system passively seeds itself. Such passive seeding may include, for example, using the user's geographic information or social network information to generate seed information.

An additional example of cross-platform recommendations includes recommendations provided for TV content, for example, based on the collected website information for a browsing history. Another example of a cross-platform recommendation includes a recommendation for TV content based on collected CD information. Another example of cross-platform recommendations includes the recommendations for a CD based on program information collected for TV programs watched on the TV. Another example of cross-platform recommendations includes the recommendation for a website based on the program information collected by the remote control device. For example, if the use information includes the titles of a number of western movies, the recommendation engine may be configured to include a set of recommendations for web pages where the web pages include information for a history of the west. For example, a link or a web address for the website for an on-line encyclopedia for a history of the west may be placed in the set of recommendations by the recommendation engine. Alternatively, if the user browses a number of website for cowboy history and this information is collected in the use information, the set of recommendations may include a set of movie titles for cowboy movies, a set of CD titles for cowboy music, titles for cowboy novels, etc. Another example of a cross-platform recommendation includes the recommendation of books in the same genre as a movie. The set of recommendations may include locations at which a book may be purchased, and may include a link to a website for Web based retailer selling the recommended book.

In embodiments, social networking and similar user associations may be used to enhance various content suggestion, and may provide, for example, cross-platform and/or synchronized consumption of related or similar content. For example, associated users in different locations, with different media schedules, content and/or providers, may want to watch the same content/program together, but they may not get the same local TV stations or be time delayed. In this or other cases the recommendation engine may be configured to search and find an alternate source for the content (another TV channel, streaming, etc) that would allow the two users to consume the content in unison. In embodiments, an additional source of use information may be provided (e.g. recognizing that a user often consumes what an associated user is), and may be used to source synchronized content by the recommendation engine. For example, a server may catalogue associated users' content consumption and/or allow a user to “friend” another user with or without further specifying what types of content the user is interested in synchronized consumption with the other user. The system can then be configured to provide alerts to the user when a desired synchronized event is possible, which may involve cross-platform and/or different sources of the content.

According to one embodiment of the present invention, server system 120 is configured to accept and store user-favorites information from a plurality of remote control device users and/or computer system users. The user-favorites information may include data that identifies a variety of media, such as books, movies, music, TV programs, etc. According to one embodiment, the various users who provide the user-favorites information to the server system may be organized into user groups. According to one embodiment, the recommendation engine may be configured to generate initial sets of recommendations based on use information 300 and the user-favorites information. For example, if a given user is a member of a user group, the server system may be configured to generate an initial set of recommendations based on the user-favorites information for the user group. The initial set of recommendations may be filtered based on various pieces of the use information, such as the time information, the geographic information, the channel information, etc.

According to one example, user-favorites information for a given user group may include a set of movie titles for favorite movies and may include a set of music titles for favorite music. A member of the given user group may submit use information to the computer system or the server system that indicates that the given user regularly watches a particular situation comedy. The use information for the particular situation comedy may be garnered from the given user's remote control device or computer system as described above. The recommendation engine may be configured to generate a set of recommendations for the user that includes a program guide for times that the particular situation comedy is being broadcast in the given user's geographic location. The recommendation engine may be configured to uniquely indicate particular episodes of the situation comedy that are in the user-favorites information. For example, the program guide may include bolded text or otherwise highlight entries that are in the user-favorites information to indicate to the given user that these episodes of the situation comedy are recommended by member of the user group. Alternatively, the recommendation engine may be configured to generate a unique set of recommendations that includes the user-favorites information for the user's user group.

According to another example, user-favorites information for a given user group may include a set of movie titles for favorite movies and may include a set of music titles for favorite music. A member of the given user group may submit use information to the computer system or the server system that indicates that the given user regularly watches movies in the genre documentary. The recommendation engine may be configured to generate a set of recommendations for the user that includes all of the documentaries in the user-favorites information for the user's user group.

According to another example, user-favorites information for a given user group may include a set of movie titles for favorite movies and may include a set of music titles for favorite music. A member of the given user group may submit use information to the computer system or the server system that indicates that the given user likes a given actor. The recommendation engine may be configured to generate a set of recommendations for the user that includes all of the content that includes the given actor. Those of skill in the art will recognize other recommendations that may be included in the set of recommendations based on user-favorites information. The user-favorites information may be collected on the remote control device or the computer system via the display of set of questions, which a user may answer via button presses on the set of control buttons or via the computer system's keyboard.

According to one embodiment of the present invention, the recommendation engine may be configured to query a plurality of information sources to generate the set of recommendations. The query may be issued to the content database, to an internet search engine, to a specific website known to provide content, to a retail store's database, etc. For example, the recommendation engine may be configured to issue a query to the content database or the Internet for broadcast television programs, video on demand (VoD), pay per view (PPV) programs, the United Gamers Coalition (UGC), Netflix™, Joost™, etc. Content information returned from the query may be included in the set of recommendations and provided to the remote control device or the computer system.

According to one embodiment, the recommendation engine may be configured to execute searches using a search engine. The search engine may be configured to perform web based searches. The recommendation engine may be configured to provide the use information to the search engine where the search engine uses the use information to perform the web based searches. The recommendation engine may be configured to parse the search results provided by the search engine to identify content that may be included in a set of recommendations. For example, if the use information includes an actor's name for a movie that the user has watched or that the use has been included in a favorites list, the recommendation engine may supply the actor's name to the search engine to determine, for example, that the actor also has a hip-hop CD available, and the recommendation engine may include the title for the hip-hop CD in a set of recommendations. According to a further example, the use information provided to the search engine from the recommendation engine may include a number of terms that the search engine might search on to generate a more focused search for content. For example, the recommendation engine may provide use information to the search engines that includes a genre for movies and includes an actors name. The search engine may perform a relatively more focused search than the search performed on just the actor's name. The recommendation engine may be configured to parse the search results and include information located in the set of recommendations.

According to one embodiment, the recommendation engine may be configured to use the user favorites information to generate a set of recommendations for a first user who has similar use information as compared with a second user who entered the user favorites information into the server system. For example, if: i) the use information for the first user indicates that the first user watches western movies, ii) the use information for the second user indicates that the second user also watches western movies, and iii) the user favorites information for the second user includes movie titles for a set of western movies, then the recommendation engine may be configured to generate a set of recommendations for the first user that includes the movie titles for the set of western movies. The set of recommendations may include a movie guide for the set of western movies, may include web links to web sellers selling DVD for the movie titles, etc. Those of skill in the art will recognize other examples.

According to a specific embodiment where the remote control device is a smart phone, the smart phone is configured to run a remote control application. A key layout for standard remote control may be presented on the smart phone's screen. As a user presses the keys in the key layout, the remote control application is configured to save use information associated with the key presses. The smart phone may be configured to transmit the use information to the server system through a mobile telephone communication, a WiFi communication, an IR communication, etc. The recommendation engine operating on the server system may be configured to generate the set of recommendations based on the use information and transmit the set of recommendations to the smart phone via the communication paths discussed immediately above. The use information collected by the smart phone may include any of the use information discussed above, and the set of recommendations may include any of the recommendations discussed herein. According to one embodiment, the remote control application may be configured to permit a user to organize the key layout as desired.

According to a further embodiment, the remote control device is configured to send a control communication to the set of home entertainment appliances to control one or more operations of the set of home entertainment appliances. The control communication may include a command for recording a program that is recommended in the set of recommendations. To this end, the control communication may include a set of commands for turning on various home entertainment appliances. The control communication may also include a command for tuning (or selecting) various settings on one or more of the home entertainment appliances, such as i) selecting the appropriate set-top box input (e.g., cable, satellite, Internet, antenna, etc), and ii) tuning to a select TV channel, radio station, internet address, etc. The control communication might not be just for recording, but also for just having a piece of media played. Having a piece of media played (turning on the TV to a particular channel) serves as a reminder that a user wanted the piece of media played. If the user does not want the piece of media played at that given time, the user may simply turn off her home entertainment appliances. The smart phone might alternatively be configured to issue a reminder to the user that a piece of media is about to be broadcast or the like. The reminder might be an alarm, a text message (or the like), a phone call with an audible message, or the like.

According to one embodiment of the present invention, the remote control is configured to directly tune to a piece of content based on selection of one item in a set of recommendations. According to another embodiment, of usage data is correlated with content choices the user has access to, in order to guarantee a match (smart recommendation). The remote control may also recommend content available on a service or a channel the user does not subscribe to yet, and therefore entices a user to subscribe to the service. A provider of the remote control or other provider may receive a royalty for users who subscribe to services recommended for the content or server not yet subscribed to. According to one embodiment of the present invention, analysis of data may include trends in data aggregated over time in order to identify preferred content types. According to one embodiment of the present invention, the same content item may be recommended on different sources, offering user options in time versus price.

According to one embodiment of the present invention, a recommendation algorithm knows what activity the system is in or what service is active when a button is depressed, in order to infer the preferred source of content (device or service). Once the user selects a recommended content item, the remote control will control the appliance's states, select the source, logs into the service (if needed) and/or tune into the right channel. U.S. Pat. No. 6,784,805 describes a remote control system for controlling appliances based on prior determined states of the appliances and is incorporated by reference herein for all purposes.

### Data Collection and Analysis

In accordance with an embodiment of the present invention, data is collected and analyzed in order to generate a set of recommendations, step 410. U.S. patent application Ser. No. 11/408,440, of Godwin Liu et al., titled “System and Method for Adaptive Programming of a Remote Control,” which is incorporated by reference herein for all purposes, describes a portable device, such as a remote control, configured to log and store information for user initiated events, and an analysis module configured to analyze the information for use patterns and to configure portable device based on the use patterns. U.S. patent application Ser. No. 10/984,954, of Frank O'Donnell et al., titled “Systems and Methods for Awarding Affinity Points Based Upon Remote Control,” which is incorporated by reference herein for all purposes, describes a portable device, such as a remote control, configured to track a user's use of the portable device, and award affinity points for discounts on purchases based on the tracked use. U.S. patent application Ser. No. 12/387,631, of Frank O'Donnell et al., titled “Systems and Methods for Awarding Affinity Points Based Upon Remote Control,” which is incorporated by reference herein for all purposes, describes a portable device, such as a remote control, configured to track a user's use of the portable device, and award affinity points for discounts on purchases based on the tracked use. U.S. patent application Ser. No. 10/119,264, of Paul V. Darbee et al., titled “Program Guide on a Remote Control,” which is incorporated by reference herein for all purposes, describes a portable device, such as a remote control, configured to track a user's use of the portable device, and display on electronic program guide on the portable device. U.S. patent application Ser. No. 11/484,555 of Gavin Robert Ferris, titled “Communication System and Method,” which is incorporated by reference herein for all purposes, describes a remote control apparatus for receipt of wireless incoming data transmissions from a host device display information related to a currently played program on a TV or the like. U.S. patent application Ser. No. 11/982,554 of Gavin Robert Ferris, titled “Communication System and Method,” which is incorporated by reference herein for all purposes, describes a remote control apparatus for receipt of wireless incoming data transmissions from a host device display information related to a currently played program on a TV or the like.

According to one embodiment, the analysis is performed on the remote control. According to another embodiment, the analysis is performed on a remote server. In one embodiment, the analysis is performed on a local host (e.g., a personal computer, a set-top box, etc.). The remote control may be connected to the local host in a wired or wireless manner. The remote control may be connected to the remote server either via a local host or directly, in any combination of wired and wireless connectivity. Wireless connectivity may be over a WAN or LAN network, PAN network, Bluetooth, home network, using RF technology, IR technology, over a cellular network, etc. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). Network 320 may also include commercially available subscription-based services such as, for example, AOL from America Online, Inc. (Dulles, Va.) or MSN from Microsoft Corporation (Redmond, Wash.). Network 320 may also be a home network, an Ethernet based network, a network based on the public switched telephone network, a network based on the Internet, or any other communication network. Any of the connections in network 320 may be wired or wireless.

The data collected and analyzed includes in one embodiment, individual usage tracking In one embodiment, aggregate usage tracking/trending is collected and analyzed. In one embodiment, both individual and aggregate usage is tracked and analyzed.

In one embodiment, individual usage tracking refers to the habits of a specific user or a specific family over time. By doing this, the recommendations generated are based, at least in part, on these viewing habits and searching habits. Such habits can include not only the channel the user watches, for how long, at what times and days, etc., but also what the user searches for, what the user marks as her favorite channels.

Such usage data may include information about how many shows have been watched, which shows, for how long the user stayed on a particular channel, and so on.

In one embodiment, aggregate usage tracking and usage trending includes tracking viewing and searching habits of specified and subscribed-to communities (e.g., fans of a particular Facebook page, users of Twitter, other social network groups, etc.), or anonymous/unspecified communities, such as geographical communities (e.g., the population in New York city, the population of California, the population of the U.S., etc.) or such as users of a particular database or brand (e.g., the installed base of users using the Harmony brand of remote controls). The aggregate user tracking/trending may combine these types of communities (e.g., users of Twitters who are located in the U.S.).

### Generating Recommendations

In one embodiment, recommendations are generated based on the initial seeding and/or the usage tracking, step 420. The recommendations may be generated on the remote control, on a local host (e.g., computer, set-top box, etc.), or on a remote server.

Recommendations are generated using one or more of a plurality of methods. The methods may be based on correlations between particular content (shows that have been viewed/searched for), and other content that is similar in nature (e.g., other shows of a similar genre, other shows having the same actor/actress/director, etc.). The recommended content may be from various applications and/or services. The content may include, but is not limited to, videos/TV/movies watched, music listened to, Internet browsing, specific web sites, specific web pages, geo-tagged pictures, and user generated content as well as commercial content.

In one embodiment, recommendations span time and span content. For instance, in one embodiment, recommended content may be across different mediums and services. For instance, if a user often watches and/or searches for tennis matches on TV, a possible recommendation may include a website which has information on various professional tennis players. According to another example, if a user watches a documentary about a particular musician, one recommendation may be music composed by that musician. As still another example, a movie scheduled to show next week may be recommended to the user, so the user can program his DVR to tape it.

### Implementation and Control

The generated recommendations may be presented to a user in a variety of ways, step 430. For instance, the recommendations may be presented as a list, in a grid, as a hierarchy of nested menu, etc. In one embodiment, the recommendations may be characterized by source (e.g., live, recorded, DVD, set-top box, service, etc.). In one embodiment, a content recommendation may be accompanied by a choice of various sources, with different price and quality options provided to the user. In one embodiment, the presentation is independent of the source. In one embodiment, the presentation is categorized by the day/time. It should be understood by one skilled in the art that various other specific implementations/presentations of the recommendations are possible. Further, the actual implementation in any embodiment may be a combination of many such presentations.

The user may have various options/controls possible for any of the content recommended. One option is for the user to consume the recommended content at the time the recommendation is seen by the user. Another option is for the user to mark the content for future recording/scheduling, or to flag the content for being reminded about the content at a later time (e.g., an hour before the show is being broadcast). Still another option is for the user to subscribe to a new service/application (e.g., to new services, channels, etc.)

In one embodiment, the user may directly tune to the recommended content. U.S. patent application Ser. No. 12/387,631, of Frank O'Donnell et al., titled “SYSTEMS AND METHODS FOR AWARDING AFFINITY POINTS BASED UPON REMOTE CONTROL USAGE,” which is incorporated by reference herein for all purposes, described a portable device, such as a remote control, that is configured FOR direct tuning of a television. The direct tuning apparatus and method described in U.S. patent application Ser. No. 12/387,631 may be used herein to directly tune an appliance. In one embodiment, once the user selects a recommended content item, the remote control will control the states (physical and logical states) of various appliances and/or services, select the source, log into the service (if needed) and/or tune into the right channel. In one embodiment, the user may select the recommended content, and the various appliances controlled by the remote control will automatically be put into the appropriate state to provide the recommended content. For instance, consider a scenario where all of the devices controlled by the remote control are turned off. If the user selects a show for viewing that is already recorded on his DVR, the TV will be turned on, turned to the appropriate mode if needed, the receiver will be turned on and tuned to the appropriate mode if needed, the DVR will be turned on and the recorded shows will be located and the appropriate show will be selected. As another example, if the recommended content is a subscription website, the various devices are placed in the appropriate states. For example, the browser is pulled up, the website URL is entered, and the user is logged in. From a user's perspective, selecting a recommendation result, in such an embodiment, in the content being seamlessly provided, regardless of the content, the states of the various devices being controlled, etc. In one embodiment, it is important for the remote control to know the current physical and logical states of the various devices and services in order to implement such a direct tune functionality. U.S. Pat. No. 6,784,805, of Harris et al., titled “State-Based Remote Control System,” which is incorporated by reference herein for all purposes, describes a remote control and a remote control system configured to track, calculate, and store the states of a variety of controlled devices so that intelligent control decisions may be made and executed by the remote control and the remote control system. Various methods and apparatus described herein for generating and making recommendations may use the methods and apparatus described in U.S. Pat. No. 6,784,805 for determining the states of a set of controlled devices and determining from these states the particular content consumed by a user, the channels watched by a user, the services used by a user, the games played by a user, etc. so that recommendations may be generated and made to a user based on the states and the content, services, etc. determined from the states. U.S. patent application Ser. Nos. 10/870,339, 11/841,748, 11/411,398, and 11/841,753, of Glen Harris, titled “State-Based Remote Control System,” which are incorporated by reference herein for all purposes, similarly describe a remote control and a remote control system configured to track, calculate, and store the states of a variety of controlled devices so that intelligent control decisions may be made and executed by the remote control and the remote control system.

The foregoing description is not limiting on the claims and variations, which are included in the instant application, will be apparent to those of skill in the art. For example, the processes described herein may be implemented using hardware components, software components, and/or any combination thereof. The specification and drawings are, accordingly, to be regarded in an illustrative sense rather than a restrictive sense. For example, while the forgoing description has discussed the computer system and the server system storing are configured to store and execute the recommendation engine, the remote control device may be configured to store and execute the recommendation engine and present the set of recommendations. According to another example, while the computer system and the server system are described as different systems, the computer system and the server system may be a single server system. It will be evident that various modifications and changes may be made without departing from the broader spirit and scope of the invention as set forth in the claims and that the invention is intended to cover all modifications and equivalents within the scope of the following claims.

What is claimed is:

1. A device configured to control a set of home entertainment appliances comprising:
a processor;
a transceiver; and
a display coupled to the processor;
wherein the processor is configured to:
collect use information associated with controlling the set of home entertainment appliances, and
communicate the use information to a computer system,
wherein the computer system is configured to:
analyze the use information to determine a set of content related to the use information, and
generate a set of recommendations that includes information that identifies the set of content.

2. The device of claim 1, wherein the device is included in a remote control device.

3. The device of claim 1, wherein the device is included in a smartphone.

4. The device of claim 1, wherein the computer system is online or off-line, and wherein the device is configured to communicate with the computer system over a plurality of networks

5. The device of claim 4, wherein the plurality of networks includes a wireless home network, wired home network, or a cellular network.

6. The device of claim 1, wherein the set of recommendations includes a list of content choices along a timeline that identifies the set of recommendations.

7. The device of claim 6, wherein the list of content choices along the timeline is a program guide.

8. The device of claim 1, further comprising:
a set of controls coupled to the processor for controlling the set of home entertainment appliances.

9. The device of claim 1, wherein the computer system is further configured to send the set of recommendations to the transceiver for display of the set of recommendations on the display.

10. The device of claim 1, wherein the use information includes button press information for the set of controls.

11. The device of claim 1, wherein the use information includes geographic information for a location at which the portable device is used.

12. The device of claim 11, wherein the geographic information is determined from GPS coordinates or an IP address received by the processor.

13. The device of claim 11, wherein the computer system is configured to generate an initial set of recommendations based on the geographic information, content sources information; and filter the initial set of recommendations based on the button press information (over time) to generate the set of recommendations.

14. The device of claim 11, wherein the computer system is configured to:
generate an initial set of recommendations based on the geographic information, and at least one of a predefined preferred show name, a predefined preferred channel, a predefined preferred actor, a predefined preferred director, a predefined preferred source, and a predefined preferred genre; and
filter the initial set of recommendations based the geographic information, and at least one of the predefined preferred show name, the predefined preferred channel, the predefined preferred actor, the predefined preferred director, the predefined preferred source, and the predefined preferred genre.

15. The device of claim 11, wherein:
the computer system is configured to generate an initial set of recommendations based on the geographic information;
the use information includes time information for a time at which the portable device is used by a user to control the set of home entertainment appliances, and
the computer system is configured to filter the initial set of recommendations to remove information from the initial set of recommendations for programs that are not at one or more times included in the time information to thereby generate the set of recommendations.

16. The device of claim 1, wherein the set of recommendations are a set of time-based recommendations for a current day or a future day so that a recommendation may be recorded or consumed.

17. The device of claim 15, wherein the use information further includes channel information for television channels that are watched, and the time information identifies the times at which the television channels are watched, and the computer system is configured to filter the initial set of recommendations to remove channels not included in the channel information to generate the set of recommendations.

18. The device of claim 1, wherein the computer system is configured to access a content database that includes user-favorites information for content identified to the computer system by a plurality of portable device users, and the computer system is configured to generate an initial set of recommendations based on the user-favorites information; and filter the initial set of recommendations based on the use information to generate the set of recommendations.

19. The device of claim 18, wherein at least one of the portable-device users is a new user and the set of recommendations are seeded recommendations for the new user, based on the new users favorites and the new user's favorites are correlated with the other portable-device user's favorites.

20. The device of claim 18, wherein the use information includes at least one of button press information, channel information, time information, geographic information, broadcast information, and favorites information.

21. The device of claim 20, wherein the favorites information includes at least one of a predefined preferred show name, a predefined preferred channel, a predefined preferred actor, a predefined preferred director, a predefined preferred source, and a predefined preferred genre.

22. The device of claim 20, wherein the set of recommendations includes cross-platform recommendations.

23. The device of claim 22, wherein cross-platform recommendations include recommendations from different providers including a broadband service provider and broadband services.

24. The device of claim 23, wherein a cross-platform recommendation includes a recommendation for a type of media that is different from a type of media associated with the use information.

25. A method of operation of a portable system for suggesting content to a user, the method comprising:
at a server system:
receiving use information of a portable device, which is configured to control a set of entertainment appliances;
accessing a content database configured to store content information for content;
comparing the use information with content information to determine if a portion of the content information is related to a portion of the use information,
generating a set of recommendations for a portion of the content information, which is related to the portion of the use information; and
sending the set of recommendations f to the portable device.

26. The method of claim 25, wherein the portable device is a remote control device.

27. The method of claim 25, wherein the step of generating the set of recommendations includes determining a channel in use, based on a sequence of button presses, based on the location of the portable device, based on a service provider, and based on a program guide for content the user subscribes to;
determining a show from the determined channel, based on the time of day, based on the context in which the button was depressed, based on whether the user was consuming a live broadcast or a recorded show, based on whether content was from broadband, based on whether content was from a broadcast.

28. The method of claim 27, whether the user liked the selected show, depending on how soon a new piece of content was selected.

29. The method of claim 25, wherein the portion of content information is related to the portion of the use information if a genre of the portion of content information is the same as a genre for the portion of the use information.

30. The method of claim 29, wherein the portion of the content information is for the same media type as a media type of the portion of the use information.

31. The method of claim 29, wherein the portion of the content information is for a different media type than a media type of the portion of the use information.

32. A non-transitory computer-readable storage medium comprising a plurality of computer-readable instructions tangibly embodied on the computer-readable storage medium, which when executed by a computer processor, controls a set of home entertainment appliances comprising:
instructions that cause the data processor to receive use information for use of a portable device, configured to control a set of entertainment appliances;
instructions that cause the data processor to access a content database configured to store content information for content;
instructions that cause the data processor to compare the use information with content information to determine if a portion of the content information is related to a portion of the use information; and
instructions that cause the data processor to generate a set of recommendations for a portion of the content information, which is related to the portion of the use information;
instructions that cause the data processor to send the set of recommendations to the portable device.

33. The computer program product claim 32, wherein the portable device is a remote control device.

34. The computer program product claim 32, wherein the code for the step of generating the set of recommendations includes code for determining a channel in use, based on a sequence of button presses, based on the location of the portable device, based on a service provider, and based on a program guide for content the user subscribes to;
code for determining a show from the determined channel, based on the time of day, based on the context in which the button was depressed, based on whether the user was consuming a live broadcast or a recorded show, based on whether content was from broadband, based on whether content was from a broadcast.

35. The computer program product of claim 32, wherein the portion of content information is related to the portion of the use information if a genre of the portion of content information is the same as a genre for to the portion of the use information.

36. The computer program product of claim 35, wherein the portion of the content information is for the same media type of as a media type of the portion of the use information.

37. The computer program product of claim 35, wherein the portion of the content information is for a different media type than a media type of the portion of the use information.

38. A method for recommending appropriate content to a user, the method comprising:
collecting data regarding a user's content consumption;
generating recommendations for content based upon the data; and
providing the user with the generated recommendations, wherein the generated recommendations are independent of the source of the recommended content and a time at which the recommended content is available.
